(19) United States
(12) Patent Application Publication
(10) Pub. No.: US 2019/0040242 A1
(43) Pub. Date: Feb. 7, 2019

(54) POLYMER BLENDS FOR IMPROVED GAS BARRIER PROPERTIES

(71) Applicant: INVISTA NORTH AMERICA S.A R.L., WILMINGTON, DE (US)

(72) Inventors: Uwe BAYER, Gessertshausen (DE); David W. BERBERICH, Avondale, PA (US); Robert L. JONES, Jr., Wilmington, DE (US); Anne NEUBIG, Augsburg (DE); Qun SUN, Wilmington, DE (US)

(73) Assignee: INVISTA NORTH AMERICA S.A R.L., WILMINGTON, DE (US)

(21) Appl. No.: 15/758,769

(22) PCT Filed: Oct. 11, 2016
(86) PCT No.: PCT/US2016/056430

§ 371 Date: Mar. 9, 2018

Related U.S. Application Data
(60) Provisional application No. 62/242,464, filed on Oct. 16, 2015.
(60) Provisional application No. 62/345,018, filed on Jun. 3, 2016.
(60) Provisional application No. 62/372,712, filed on Aug. 9, 2016.

(51) Int. Cl. C08L 23/12; C08L 77/06; C08L 71/00; C08L 23/06; C08L 39/06

(52) U.S. Cl. CPC C08L 23/12; C08L 77/06; C08K 5/098; C08L 23/06; C08L 39/06; C08L 71/00

(57) ABSTRACT

The present invention relates to novel polymer compositions and their use in polyolefin resins. Films and rigid or semi-ridged articles made from these novel polymer compositions provide improved oxygen and/or carbon dioxide barrier protections.

### RELATED APPLICATIONS

This is related to Provisional Patent Applications No. 62/242,464, filed in the United States Patent and Trademark Office on Oct. 16, 2015, and No. 62/345,018, filed in the United States Patent and Trademark Office on Jun. 3, 2016, and No. 62/372,712, filed in the United States Patent and Trademark Office on Aug. 9, 2016.

### BACKGROUND

Polymers such as polyesters and polyolefins have been replacing glass and metal packaging materials due to lighter weight, decreased breakage compared to glass, and potentially lower cost. One major deficiency with standard polyesters and polyolefins, however, is relatively high gas permeability. This curtails the shelf life of carbonated soft drinks and oxygen sensitive beverages or foodstuff such as beer, wine, tea, fruit juice, ketchup, cheese and the like. Organic and inorganic oxygen scavenging materials have been developed partly in response to the food industry's goal of having longer shelf-life for packaged food. These oxygen scavenging materials are incorporated into at least a portion of the package and remove oxygen from the enclosed package volume thereby inhibiting spoilage and prolonging freshness.

Articles made of polyolefinic materials, such as polyethylene (PE) and polypropylene (PP) films, plastic packaging, beverage bottles, etc., tend to display good moisture barrier and thermal processing performance, but perform poorly in preventing oxygen permeation across the wall that is in contact with the filled contents.

In bottle applications, polypropylene (PP) in particular is typically used as a copolymer with ethylene to provide impact resistance and flexibility. Adding co-monomers may lower the melting temperature and result in a higher oxygen transmission rate, both being undesirable in hot-filled, oxygen sensitive food packages.

In some applications, polyethylenes (PEs) such as HDPE moisture vapor transmission rate (MVTR) grades are high density and provide improved moisture barrier over LDPE and PP. However, PE and PP are generally co-extruded, laminated, layered and coated or surface-treated with polymers such as ethylene-vinyl alcohol (EVOH) to increase the oxygen barrier properties. This results in a more complex and expensive technology.

Other examples may include increase in the barrier properties of polypropylene as a single (mono)-layered material including passive (torturous path) technologies (such as blending in clays or “layered silicate” nanocomposites), or with addition of nanocomposites in situ.

One method of addressing gas permeability involves incorporating an oxygen scavenger into the package structure itself In such an arrangement, oxygen scavenging materials constitute at least a portion of the package, and these materials remove oxygen from the enclosed package volume, thereby inhibiting spoilage and prolonging freshness in the case of food products.

Suitable oxygen scavenging materials include oxidizable organic polymers in which either the backbone or the side-chains of the polymer react with oxygen. Such oxygen scavenging materials are typically employed with a suitable catalyst, for example, an organic or inorganic salt of a transition metal such as cobalt. One example of an oxidizable organic polymer is a polyether. The polyether is typically used as polyester-ether copolymer and in low amounts of less than 10 weight percent of the packaging material. Typically, the polyester-ether is dispersed in the polymer matrix and can form discrete domains.

U.S. Pat. No. 5,641,825 relates to a composition of matter having oxygen scavenger capabilities, to a method of improving the oxygen scavenging capability of polymer-metal salt blends and to articles of manufacture formulated with such blends.

United States Patent Application No. 201410073741A1 relates to oxygen barrier polymers and, in particular, polyolefins with active oxygen scavenging systems.

United States Patent Application No. 2012/0252922A1 relates to a polymer composition comprising polypropylene, an adhesive polymer, and an oxygen-absorbing composition and its use for the manufacture of goods.

It may be possible to make significant oxygen barrier protection improvements by increasing the level of transition metal-based oxygen scavenging catalysts. However, increasing the transition metal levels may impact the visual appearance and properties for the food and beverage containers. For example, higher cobalt level could impart blue coloration to otherwise clear containers. The problem, therefore, is to bring improvements to the oxygen barrier performance while not compromising the visual properties of the food and beverage containers.

Examples of efforts to improve oxygen barrier performance of packaging materials used for food and beverage containers may be found in European Patent Application No. 0546546 A1, disclosing a resin composition, e.g. made into a film, sheet or container, comprising a polyolefin, a thermoplastic resin, and transition metal catalyst; U.S. Pat. No. 8,962,740, disclosing an oxygen scavenging composition, e.g. made into a film by “compression molding”, comprising polyolefin, oxidizable polymer, and transition metal catalyst; U.S. Pat. No. 8,592,522, disclosing an oxygen absorbing resin composition, e.g. made into a film, sheet or container, comprising polyolefin, other resin “which acts as a trigger for oxidation”, and transition metal catalyst; U.S. Pat. No. 7,691,290, disclosing a composition, e.g. made into a film, sheet or “preform”, comprising a base polymer, non-polymeric oxidizable organic, and transition metal catalyst; and U.S. Pat. No. 7,608,341, disclosing an oxygen absorption resin composition, e.g. Made into a film, sheet or container, comprising thermoplastic resin, “gas barrier resin”, and transition metal catalyst. Other examples include U.S. Pat. No. 7,186,464, disclosing an oxygen barrier composition, e.g. Made into a film or “rigid article”, comprising an oxygen barrier polymer, oxygen scavenging polymer, and transition metal catalyst; U.S. Pat. No. 5,639,815, disclosing a package wall comprising “a base polymer which includes an oxidizable organic polymer”, and transition metal catalyst; U.S. Pat. No. 6,455,620, disclosing a composition, e.g. Made into a film or rigid container, comprising a thermoplastic polymer, an oxygen scavenging composition, and transition metal catalyst; and U.S. Pat. No. 7,514,152, disclosing an oxygen scavenger film including a blend of an oxygen scavenger and a polymer, and a transition metal catalyst.

It would be desirable to make significant oxygen barrier protection improvements in polymers of the type used in bottle and food containers which lack sufficient gas barrier properties. In some applications, it would be desirable to make polymer articles and containers with preferential gas permeability (ethylene and carbon dioxide).

### SUMMARY

One aspect of the present invention is directed to a composition providing improved gas barrier properties comprising: a) polyolefin, b) polymer containing an oxidizable component, said polymer selected from the group consisting of polyethers, copolyether esters, copolyether amides, polyether glycols, at least partially aromatic polyamides, and combinations thereof, c) transition metal or metal compound, and d) optionally separately added additive, e.g. stabilizer, said composition characterized in that when an article, for example film, semi-rigid or rigid structure, is formed therefrom and oriented in the x and/or y direction, the article exhibits lower oxygen and/or carbon dioxide transmission than an article formed from a composition without components b) and c) when oriented in the x and/or y direction, or with components b) and c) when not oriented in the x and/or y direction.

Another aspect of the present invention is directed to a composition providing improved gas barrier properties comprising: a) from 90 to 99.5 parts polyolefin, b) from 0.1 to 10 parts of polymer containing an oxidizable component, said polymer selected from the group consisting of polyethers, copolyether esters, copolyether amides, polyether glycols, at least partially aromatic polyamides, and combinations thereof, c) from 10 to 1000 parts per million (ppm), for example ≥10 ppm to ≤600 ppm, for example ≥10 ppm to ≤400 ppm, of transition metal, e.g. cobalt, or metal compound, e.g. cobalt carboxylate or stearate, and d) optionally from 0 to 5 parts of separately added additive, e.g. stabilizer, such as, for example, a monomeric, oligomeric or polymeric hindered amine light stabilizer (HALS), said composition characterized in that when an experimental article, for example film, semi-rigid or rigid structure, is formed therefrom and oriented in the x and/or y direction from 50 to 400%, the article exhibits lower oxygen and/or carbon dioxide transmission than a comparative article formed from a composition without components b) and c) when oriented in the x and/or y direction from 50 to 400%, or with components b) and c) when not oriented in the x and/or y direction from 50 to 400%, wherein the experimental article and the comparative article have the same finished wall thickness.

Another aspect of the present invention is directed to the above composition providing improved gas barrier properties wherein the polymer b) containing an oxidizable component comprises a polyamide, e.g. MXD6, and wherein the separately added additive d) comprises compatibilizing agent, such as, for example, selected from the group consisting of polyolefins grafted with COPE, maleic anhydride grafted polypropylene, maleic anhydride grafted polyvinyl pyrrolidone, maleic anhydride (MAH), PTMEG, and combinations thereof. Thus in one embodiment, the polymer b) containing an oxidizable component is the partially aromatic polyamide MXD6 and the separately added additive d) is polyolefin grafted with copolyether ester (COPE).

Another aspect of the present invention is directed to film having improved oxygen or carbon dioxide or both barrier properties comprising: a) polyolefin, b) polymer containing an oxidizable component, said polymer selected from the group consisting of polyethers, copolyether esters, copolyether amides, polyether glycols, at least partially aromatic polyamides, and combinations thereof, c) transition metal or metal compound, and d) optionally separately added additive, e.g. stabilizer, such as, for example, a monomeric, oligomeric or polymeric hindered amine light stabilizer (HALS), said film having been oriented in the x and/or y direction from 50 to 400%.

Another aspect of the present invention is directed to film having improved oxygen or carbon dioxide or both barrier properties comprising: a) from 90 to 99.5 parts polyolefin, for example 90 to 99 parts polyolefin, b) from 0.1 to 10 parts of polymer containing an oxidizable component, said polymer selected from the group consisting of polyethers, copolyether esters, copolyether amides, polyether glycols, at least partially aromatic polyamides, and combinations thereof, c) 10 to 1000 parts per million (ppm), for example ≥10 ppm to ≤600 ppm, for example ≥10 ppm to ≤400 ppm, and d) optionally from 0 to 5 parts of separately added additive, e.g. stabilizer, such as, for example, a monomeric, oligomeric or polymeric hindered amine light stabilizer (HALS), said film having been oriented in-the x and/or y direction from 50 to 400%.

Another aspect of the present invention is directed to the above film having improved oxygen or carbon dioxide or both barrier properties wherein the polymer b) containing an oxidizable component comprises a polyether, and wherein the film further comprises at least one compatibilizing agent, such as, for example, selected from the group consisting of polyolefins grafted with COPE, maleic anhydride grafted polypropylene, maleic anhydride grafted polyvinyl pyrrolidone, maleic anhydride (MAH), PTMEG, and combinations thereof.

Another aspect of the present invention is directed to the above film having improved oxygen and/or carbon dioxide barrier properties wherein the polymer b) containing an oxidizable component comprises a polyamide, e.g. MXD6.

Another aspect of the present invention is directed to a rigid or semi-rigid article having improved oxygen or carbon dioxide or both barrier properties comprising: a) polyolefin, b) polymer containing an oxidizable component, said polymer selected from the group consisting of polyethers, copolyether esters, copolyether amides, polyether glycols, at least partially aromatic polyamides, and combinations thereof, c) transition metal or metal compound, and d) optionally separately added additive, e.g. stabilizer, such as, for example, a monomeric, oligomeric or polymeric hindered amine light stabilizer (HALS), said rigid or semi-rigid article having been oriented in the x and/or y direction from 50 to 400%.

Another aspect of the present invention is directed to a rigid or semi-rigid article having improved oxygen or carbon dioxide or both barrier properties comprising: a) from 90 to 99.5 parts polyolefin, b) from 0.1 to 10 parts of polymer containing an oxidizable component, said polymer selected from the group consisting of polyethers, copolyether esters, copolyether amides, polyether glycols, at least partially aromatic polyamides, and combinations thereof, c) 10 to 1000 parts per million (ppm), for example ≥10 ppm to ≤600 ppm, for example ≥10 ppm to ≤400 ppm, of transition metal or transition metal compound, and d) optionally from 0 to 5 parts of separately added additive, said rigid or semi-rigid article having been oriented in the x and/or y direction from 50 to 400%.

Another aspect of the present invention is directed the above rigid or semi-rigid article having improved oxygen or carbon dioxide or both barrier properties wherein the polymer b) containing an oxidizable component comprises a polyether, and wherein the article further comprises at least one compatibilizing agent, such as, for example, selected from the group consisting of polyolefins grafted with COPE, maleic anhydride grafted polypropylene, maleic anhydride grafted polyvinyl pyrrolidone, maleic anhydride (MAH), PTMEG, and combinations thereof.

Another aspect of the present invention is directed to the above rigid or semi-rigid article having improved oxygen or carbon dioxide or both barrier properties wherein the polymer b) containing an oxidizable component comprises a polyamide, e.g. MXD6.

### DETAILED DESCRIPTION

The term “barrier”, as used herein, means a material formation or structure that prevents or obstructs movement, passage or access across the two sides that the barrier separates or divides. Non-limiting examples of barrier are rigid or flexible container walls, rigid or flexible films, rigid or flexible membranes and separators.

The term “polyolefin(s)”, as used herein, encompasses a class of thermoplastic polymers that are widely used in the consumer and petrochemicals industry. Polyolefins are typically produced from a simple olefin (also called an alkene with the general formula CₙH₂ₙ) as a monomer. For example, polyethylene (PE) is the polyolefin produced by polymerizing the olefin ethylene (C₂H₄). Polypropylene (PP) is another common polyolefin which is made from the olefin propylene (C₃H₆). Copolymers of ethylene and propylene are also useful thermoplastic polymers in accordance with the present disclosure.

Other non-limiting examples of polyolefins, as used in the present disclosure, are described in U.S. Pat. No. 8,981,013 B2. These may include, but are not limited to, ethylene-based polymers such as high density polyethylene (HDPE), low density polyethylene (LDPE), linear low density polyethylene (LLDPE), homogeneously branched linear ethylene/α-olefin interpolymers or homogeneously branched substantially linear ethylene/α-olefin interpolymers; propylene-based polymers such as propylene homopolymers and propylene interpolymers that can be random or block copolymers, branched polypropylene, or a propylene-based terpolymer; a blend of two of more polyolefins, such as a blend of an ethylene-base polymer and a propylene-base polymer discussed above; halogenated ethylene-based polymers such as chlorinated ethylene-based polymers and fluorinated ethylene-based polymers.

In some embodiments of the present invention, polyolefins may also include elastomeric polymers such as homopolymers of conjugated dienes, especially butadiene or isoprene, and random, or block, copolymers and terpolymers of at least one conjugated diene, especially butadiene or isoprene, with at least one aromatic α-olefin, especially styrene and 4-methylstyrene, aromatic diolefin, especially divinylbenzene.

In other embodiments of the present invention, polyolefins may include natural or synthetic polyisoprene (PI) and polybutadiene (PB).

In some other embodiments, the improved barrier properties of the present invention may be applicable to biopolymers, biopolymer alloys and biopolymer composites.

The composition providing improved gas barrier properties may comprise a polymer containing an oxidizable component selected from the group consisting of polyethers, copolyether-esters, copolyether amides, polyether glycols, at least partially aromatic polyamides, and combinations thereof.

In some embodiments, the barrier may comprise no more than 10% by weight of the polymer containing an oxidizable component. In other embodiments, the barrier may comprise no more than 9%, no more than 8%, no more than 7%, no more than 6%, no more than 5%, no more than 4%, no more than 3%, no more than 2%, no more than 1%, or no more than 0.5% of the polymer containing an oxidizable component. All percentages are on the weight basis, relative to the total composition.

In some embodiments, the barrier may comprise ≥10% by weight and ≤50% by weight of the polymer containing an oxidizable component.

When the polymer containing an oxidizable component comprises an at least partially aromatic polyamide, the barrier may comprise ≥1 and ≤30 wt % of the polymer, for example, ≥3 and ≤15 wt % of the polymer.

When the polymer containing an oxidizable component comprises a polyether glycol, the barrier may comprise ≥1 and ≤10 wt % of the polymer, for example, ≥2 and ≤5 wt % of the polymer.

In some embodiments of the present invention, the polymer (b) containing an oxidizable component may comprise one or more polyether segments having a number-average molecular weight of from about 200 to about 5000 g/mol. In some embodiments, the polyether in the polymer composition may have a number-average molecular weight of from about 600 to about 3500 g/mol, and more specifically about 800 to about 3000 g/mol, that the polymer composition contains one or more polyether segments in an amount of about 5 to about 60 wt %, in particular about 10 to about 50 wt %.

In some embodiments of the present invention, the polymer (b) containing an oxidizable component is a copolyether ester containing polyether segments in an amount of about 15 to about 45 wt %, relative to the total polymer (b) composition.

Advantageously, the polyether segment is a poly (C₂-C₆-alkylene) glycol segment. The C₂-C₆-alkylene glycol may be a linear or branched aliphatic C₂-C₆-moiety. In some embodiments, the polyether segment is a linear or branched poly (C₂-C₆-alkylene) glycol segment.

Specific examples of such polymer compositions include poly (ethylene glycol), linear or branched poly (propylene glycol), linear or branched poly (butylene glycol), linear or branched poly (pentylene glycol), linear or branched poly (hexylene glycol) as well as mixed poly (C₂-C₆-alkylene) glycols obtained from two or more of the glycolic monomers used in preparing the above-mentioned examples. Advantageously, the polyether segment is a linear or branched poly (propylene glycol) or a linear or branched poly (butylene glycol). Compounds having three hydroxyl groups (glycerols and linear or branched aliphatic triols) could also be used.

Another aspect of the present invention is directed to a composition providing gas barrier properties, wherein the polymer b) containing an oxidizable component is a polyether, and wherein the separately added additive d) comprises at least one compatibilizing agent.

In some embodiments, the at least one compatibilizing agent may be a blend of poly-α-olefin and polyester that can be made using reactive compounding techniques using maleated polypropylene or poly[methylene (phenylene isocyanate)] or (PMPI). In other embodiments, the at least one compatibilizing agent may be acrylic-modified olefinic ionomers containing sodium, zinc, cobalt, and a variety of metals. Additional compatibilizing agents for use in the present disclosure are further described in International Review of Chemical Engineering 2011, Vol. 3, p 153-215. Other non-limiting examples of the compatibilizing agents may include anhydrides of unsaturated dicarboxylic acids, such as maleic, citraconic and itaconic acids.

Methods for producing compatibilizing agents for use herein, such as extrusion of hot melt resins, the solvothermal method, mixed monomer systems synthesis, free radical grafting by irradiation or other, are known in the art.

The term “transition metal”, as used herein, means any of the set of metallic elements occupying Groups IVB-VIII, IB, and IIB, or 4-12 in the periodic table of elements. Non-limiting examples are cobalt, manganese, copper, chromium, zinc, iron, nickel, and combinations thereof. The transition metals have variable chemical valence and a strong tendency to form coordination compounds.

The term “transition metal catalyst”, as used herein, means those transition metal catalysts that activate or promote the oxidation of the polymer composition by ambient oxygen. Examples of suitable transition metal catalysts include compounds comprising cobalt, manganese, copper, chromium, zinc, iron, or nickel. It is also possible that the transition metal catalyst is incorporated in the polymer matrix during extrusion for example. The transition metal catalyst can be added during polymerization or compounded into suitable polymer thereby forming a masterbatch that can be added during the preparation of the article. The transition metal compound, such as a cobalt compound for example, may be physically separate from the polymer composition, for example a sheath core or side-by-side relationship, so as not to activate the polymer composition prior to melt blending into a preform or bottle.

In some embodiments, the transition metal catalyst may include, but is not limited to, a transition metal salt of i) a metal comprising at least one member selected from the group consisting of cobalt, manganese, copper, chromium, zinc, iron, and nickel, and ii) an inorganic or organic counter ion comprising at least one member selected from the group of carboxylate, such as neodecanoates, octanoates, stearates, acetates, naphthalates, lactates, maleates, acetylacetonates, linoleates, oleates, palminates or 2-ethyl hexanoates, oxides, carbonates, chlorides, dioxides, hydroxides, nitrates, phosphates, sulfates, silicates, or mixtures thereof. Such cobalt metal-containing compositions may be added separately or pre-mixed into the polymer (b), which can be a copolyether ester (COPE) component.

In some embodiments, the transition metal catalyst carriers may include microcrystalline cellulose (MC) as a potential carrier for the transition metal.

In some embodiments, the oxidizable component in the polymer compositions comprising transition metals may be bio-resourced α-tocopherol, poly (alpha-pinene), poly (beta-pinene), poly (dipentene), and poly (d-limonene).

In embodiments of the present invention, the transition metal catalyst may be a cobalt salt, in particular a cobalt carboxylate, and especially a cobalt C₈-C₂₀ carboxylate. The C₈-C₂₀ carboxylate may be branched or unbranched, saturated or unsaturated. The cobalt compound may be physically separate from the polymer composition, for example a sheath core or side-by-side relationship, so as not to activate the polymer composition prior to melt blending into a container.

Another aspect of the present invention is a composition for imparting oxygen barrier properties to a composition comprising: a) polyolefin, e.g. from 90 to 99.5 parts by weight polyolefin, b) up to 10 parts by weight, e.g. from 0.1 to 10 parts, of a polymer containing an oxidizable component, said polymer selected from the group consisting of polyethers, copolyether-esters and copolyether amide; c) 10 to 1000 parts per million (ppm), for example ≥10 ppm to ≤600 ppm, for example ≥10 ppm to ≤400 ppm, transition metal or metal compound catalyst; d) up to 5 parts by weight, e.g. from 0 to 5 parts, separately added additive, e.g. stabilizer; said composition characterized in that when an article is formed therefrom and oriented in the x and/or y direction, the article exhibits lower oxygen transmission than an article formed from a composition without components b) and c) when oriented in the x and/or y direction, or with components b) and c) when not oriented in the x and/or y direction, compared with a control.

In some embodiments of the present invention, the article has been oriented at least 50% in the x direction and/or at least 50% in the y direction. In other embodiments of the present invention, the article has been oriented at least 100% in at least one direction.

In some embodiments of the present invention, the article is a gas barrier wherein the gas is oxygen, carbon oxides or both.

In some embodiments, the article is in the form of a film. In other embodiments, the article is rigid or semi-rigid structure.

The term “article”, as used herein, means a particular form or physical object that comprises the barrier composition of the present invention. Non-limiting examples of articles are stretch-molded, blow-molded, extruded physical objects of defined shapes, sizes and forms. These may include, but are not limited to, bottles, containers, hollow blocks or shapes, planar or non-planar trays, film, sheet, tubing, pipe, fiber, container preforms, blow molded articles such as rigid containers, thermoformed articles, flexible bags and the like and combinations thereof.

In some embodiments of the present invention, rigid or semi-rigid articles can be formed from plastic, paper or cardboard cartons or bottles such as juice, milk, soft drink, beer and soup containers, thermoformed trays or cups.

Embodiments of some aspects of the invention may further comprise separately added additives, such as, for example, stabilizers selected from the group consisting of monomeric, oligomeric or polymeric hindered amine light stabilizers (HALS); antioxidants; metal catalysts; ionic compatibilizers; colorant; dyes; pigments; fillers; branching agents; reheat agents; anti-blocking agents; anti-static agents; biocides; blowing agents; coupling agents; anti-foaming agents; flame retardants; heat stabilizers; impact modifiers; crystallization aids; lubricants; plasticizers; processing aids; buffers; colorants; slip agents; and combinations thereof. It will be understood that the skilled person may run trial-and-error or design experiments to determine the optimum levels of such additives for specific applications.

In some embodiments, the HALS may be a polymeric HALS, such as Uvinul® 5050, oligomeric or polymeric HALS, such as Uvinul® 5062. In some other embodiments, the HALS may be a mixture of compounds, such as Uvinul® 4092. Other suitable HALS include but are not limited to Uvinul® 4077, Uvinul® 4092, Nylostab®, Tinuvin®, Hostavin® and Nylostab® S-EED®.

Suitable examples of antioxidants include, but are not limited to, phenolic antioxidants, aminic antioxidants, sulfur-based antioxidants and phosphites, and mixtures thereof. Non-limiting examples of antioxidants are described in Plastics Additives, Pritchard, G., Ed. Springer Netherlands: 1998; Vol. 1, pp 95-107. Non-limiting examples of such antioxidants include butylated hydroxytoluene (BHT), Ethanox® 330, Ethanox® 330G, IRGANOX 1330, Hostanox® PEP-Q, tert-butyl phenols and mixtures thereof.

In some embodiments, the antioxidant may be selected from the group consisting of hindered phenols, sulfur-based antioxidants, hindered amine light stabilizers and phosphites. In a further embodiment, the antioxidant may be selected from the group consisting of hindered phenols, sulfur-based antioxidants and phosphites. Examples of such antioxidants include, but are not limited to 1,3,5-trimethyl-2,4,6-tris(3,5-di-tert-butyl-4-hydroxybenzyl)-benzene (CAS: 1709-70-2), tetrakis(2,4-di-tert-butylphenyl)-1,1-biphenyl-4,4′-diylbisphosphonite (CAS: 38613-77-3) or pentaerythritol tetrakis 3-(3,5-di-tert-butyl-4-hydroxyphenyl)propionate (CAS: 6683-19-8), (5R)-[(1S)-1,2-Dihydroxyethyl]-3,4-dihydroxyfuran-2(5H)-one (Ascorbic acid CAS: 50-81-7); α-tocopherol (vitamin E form antioxidant agent. CAS: 59-02-9).

The term “colorant”, as used herein, can be an organic or inorganic chemical compound that is capable of imparting coloration to a substance, including masking, balancing or countering the absorbance of a substance in the 300-600 nm wavelength. It may be possible to use colorants such as inorganic pigments, for example, iron oxide, titanium oxide and Prussian blue, and organic colorants such as alizarin colorants, azo colorants and metal phthalocyanine colorants, and trace nutrients such as salts of iron, manganese, boron, copper, cobalt, molybdenum and zinc. It may be advantageous for the colorants to have good thermal and chemical stability.

In some embodiments, the colorant may comprise of industrial, commercial and developmental class of pigments, dyes, inks, paint, and combinations thereof. In other embodiments, the colorant may comprise of synthetic, natural, bio-derived compounds and combinations thereof. In some other embodiments, the colorant may comprise of chemical compounds from a class of hetero-aromatic compounds. It will be understood that the skilled person may run trial-and-error experiments to determine the optimum levels of such colorants in specific applications.

In some embodiments, an ionic compatibilizer may be a separately added additive. Suitable ionic compatibilizers can for instance be copolyesters prepared by using ionic monomer units as disclosed in International Patent Application No. WO2011/031929 A2, page 5, incorporated herein by reference.

The melting point of the composition providing gas barrier properties of the present invention can be conveniently controlled by adjusting various characteristics or parameters of the composition, as known to those skilled in the art. For instance, one skilled in the art may opt to suitably select the molecular weight of the polyether segment, and/or the weight ratio of polyolefin segment to polyether segment to adjust the melting point. It is also possible to select different types of polyolefin to adjust the melting point. For example, adipic acid modified PET can be grafted via a radical process to improve adhesion to polyolefins. Thus, one skilled in the art may select or mix suitable polyolefins to reliably adjust the melting point of the polymer composition. Other options include suitably selecting the type of polyether. For instance, the chain length and the presence or absence of a side chain influences the melting point of the polymer composition. A further possibility is the addition of additives. Another possibility is the molecular weight distribution obtained by combining or otherwise mixing varying polyolefins to provide a melting range that may be in favor of thermal transitions suited to the article being formed. One embodiment of the composition providing gas barrier properties is liquid at 25° C.

In this disclosure, the term “comprising” encompasses “including” as well as “consisting” e.g. a composition “comprising” X may consist exclusively of X or may include something additional e.g. X+Y.

The following Examples demonstrate the present invention and its capability for use. The invention is capable of other and different embodiments, and its several details are capable of modifications in various apparent respects, without departing from the spirit and scope of the present invention. Accordingly, the Examples are to be regarded as illustrative in nature and non-limiting.

### Materials Used in the Examples:

Purified terephthalic acid (PTA; Chemical Abstract Registry CAS No. 100-21-0), is used in examples of the present disclosure. Monoethylene Glycol, EG or MEG (CAS No. 107-21-1), is used in examples of the present disclosure. The product specification of EG is minimum 99.9% purity by weight.

A titanium catalyst, TI-Catalyst C94, as used in examples of the present disclosure, is manufactured by Sachtleben Chemie GmbH (Germany). The titanium content in the catalyst is 44% by weight.

A commercial grade, INVISTA Terathane® 1400 Poly (tetramethylene ether) Glycol or PTMEG 1400 is used in examples of the present disclosure. Terathane® PTMEG 1400 has a number average molecular weight of 1400 g/mole, stabilized with 200-350 ppm BHT (CAS No. 128-37-0).

A commercially available antioxidant, Ethanox® 330 (CAS No. 1709-70-2), is used in examples of the present disclosure, such as that manufactured by SI Group. Typical commercial purity of Ethanox® 330 is greater than 99% by weight.

An industrial hindered amine light stabilizer HALS, Uvinul® 4050 (CAS No. 124172-53-8), as used in examples of the present disclosure, is manufactured by BASF. Uvinul® 4050, i.e., N,N′-bisformyl-N,N′-bis-(2,2,6,6-tetramethyl-4-piperidinyl)-hexamethylendiamine, is a sterically hindered monomeric amine with the molecular mass of 450 g/gmol.

Cobalt stearate (CAS No. 1002-88-6), used in Examples 2-5 of the present disclosure, is manufactured and supplied by OM Group under the “Manobond CS95” product name. The cobalt content in Manobond CS95 is 9.3-9.8% by weight and the melt point of Manobond CS95 is in the range of 80 to 95° C. Cobalt stearate (CAS No. 1002-88-6), as used in Examples 6a-6d of the present disclosure, is manufactured and supplied by Umicore under the “Ecos S 9.5: cobalt stearate 9.5%” product name.

Sodium stearate (CAS No. 68424-38-4), as used in examples of the present disclosure, is supplied by Peter Greven GmbH & Co. KG, Germany, under the “Ligastar NA R/D” product trade name. The sodium content in Ligastar NA R/D is about 6% by weight.

Magnesium stearate (CAS No. 557-04-0), as used in examples of the present disclosure, is supplied by Peter Greven GmbH & Co. KG, Germany, under the “Ligastar MG 700” product trade name. The magnesium content in Ligastar MG 700 is about 4.4% by weight.

Aromatic polyamide (poly (m-xylene adipamide)) MXD6 used in examples is commercially available from Mitsubishi Gas Chemical Company, MXD6 56007 (CAS: 25718-70-1).

Polypropylene used in examples is commercially available as Total mPP Lumicene® CAS: 9003-07-0; 9010-79-1.

Maleic anhydride grafted PP (PP-g-MA) is commercially available from Arkema under the OREVAC® CA 100 product name.

Solvaperm Yellow 2G (CAS No. 7576-65-0) with the color index of Solvent Yellow 114, as used in examples of the present disclosure, is a registered product trademark of Clariant Chemicals.

### EXAMPLES

### Example 1

### Copolyester-ether (COPE) Preparation

Copolyester-ether (COPE) is prepared using a continuous polymerization process. Direct esterification of terephthalic acid (PTA) and monoethylene glycol (EG) in a small molar excess of glycol (about 1.10:1 EG:PTA molar ratio) is performed in a primary esterification reactor at 250-260° C. and under normal pressure in the presence of titanium catalyst C94. Terathane® PTMEG 1400, at about 35 wt % based on the final copolyester-ether polymer weight, is added after esterification and the mixture is stirred for about 1 hour. Uvinul® 4050 is added late to the esterification reaction mixture and shortly before the start of polycondensation.

During the polycondensation step, the elimination of glycol under reduced pressure is started with the final polycondensation temperature in the 255-260° C. range. The final polycondensation pressure is about 1 mbar. Excess glycol is distilled out of the reaction mixture under increased temperature and reduced pressure until the desired polymerization degree is achieved. The desired polymer melt is flowed through the reactor discharge pump in a deionized water cooling bath. After the polymer strand is cooled underwater, it is pelletized with a Pell-tec pelletizer.

The intrinsic viscosity of the final copolyester-ether polymer compositions is in the 0.600 to 0.850 dl/g range. In one embodiment, 1000 kg of COPE product may be prepared using component quantities as listed in Table 1.

TABLE 1

| Component | Amount, kg |
|---|---|
| Terephthalic Acid | 562 |
| Ethylene Glycol | 231 |
| Terathane ® PTMEG 1400 | 350 |
| Uvinul ® 4050 | 2.0 |
| Ethanox ® 330 | 0.50 |
| Catalyst - C94 | 0.350 |
| Anti-foam agent | <0.5 |

### Example 2

### Cobalt-Stearate Masterbatch (Co-MB) Preparation

A PTA-based polymer, as used herein, is a commercial polyethylene terephthalate (PET) polyester product of INVISTA Resins and Fibers with the “XPURE® Polyester 7090” product name. The XPURE® Polyester 7090 is prepared according to a similar direct esterification method as described in Example 1. The PET polymer resin is dried at 150-160° C. under vacuum for 4-6 hours with dry air (<−30° C. dew point) to attain 50 ppm (max.) residual moisture content.

Cobalt stearate, sodium stearate, magnesium stearate, and Solvaperm Yellow 2G are added directly in the melt extrusion step. The melt extruder used is a co-rotating, 27 mm extruder screw diameter and screw length to diameter (L:D) ratio of 36:1, for example, Leistritz Micro 27 36D model melt extruder. The polymer processing rate is about 8 kg/hr. Stage-wise operating temperatures are: water at room temperature (T₀), 230° C. (T₁), 254° C. (T₂), 256° C. (T₃), 253° C. (T₄-T₅), 255° C. (T₆-T₇) and 260° C. (T₈-T₉). The desired molten material is extruded into a deionized water cooling bath. The cooled polymer strands are pelletized with a Pell-tee pelletizer into typical cylindrical granules of about 2 mm diameter and about 3 mm length.

Either of the cobalt and/or dye levels in the final Cobalt stearate Masterbatch (Co-MB) composition could be varied by adjusting the amounts of cobalt stearate and/or Solvaperm Yellow 2G dye, respectively.

The intrinsic viscosity of the final Co-MB polymer composition is greater than 0.45 dl/g. In one embodiment, 1000 kg of Co-MB product may be prepared using the component quantities as listed in Table 2.

TABLE 2

| Component | Amount, kg |
|---|---|
| XPURE ® Polyester 7090 | 907.2 |
| Cobalt Stearate | 42.9 |
| Sodium Stearate | 26.0 |
| Magnesium Stearate | 23.9 |
| Solvaperm Yellow 2G | 0.06 |

### Example 3

### Mixing of COPE and Co-MB

The white or off-white “salt” pellets of COPE, prepared according to Example 1, are mixed with the dark “pepper” pellets of Co-MB, prepared according to Example 2, to form a two-chip component mixture referred to as “salt and pepper” mixture. Prior to mixing the two, both COPE and Co-MB pellets are dried at about 85° C. under vacuum for about 8 hours to remove residual moisture. The salt and pepper mixture may be mixed with additional dye colorant and/or cobalt compound depending on the final cobalt and dye levels to be achieved.

It is noted here that the mixed composition, as prepared via Examples 1-3, can optionally be varied to yield different levels of cobalt; a catalytic part of this active formulation effective as oxygen barrier protection for food and beverage containers.

### Example 4

### Preparation of Copolyether Ester Elastomer Composition Comprising a Soft Segment and a Hard Segment

The soft segment of the copolyether ester elastomer composition is composed of long chain polyester which is derived from a random poly(oxyethylene-co-oxytetramethylene ether) glycol, and the hard segment is composed of short chain polyester. The hard segment may be derived from an aromatic dicarboxylic acid and a short chain diol.

As used in this example, dimethylterephthalate (DMT), polytetramethylene ether glycol (PTMEG) and poly(oxyethylene-co-oxytetramethylene ether) glycol are obtained from INVISTA. 1,4-butanediol (BDO), tetrabutyl titanate (TBT) catalyst, magnesium acetate co-catalyst and antioxidant (IRGANOX® 330 E) are purchased from Aldrich Chemical.

In this example, inherent viscosities are determined at a concentration of 0.1 g/dl in m-cresol at 30° C. and reported in dl/g. Melting points of the hard segments are determined by differential scanning calorimeter (DSC) with a heating/cooling rate of 10° C./min. The glass transition temperatures (Tg) are determined by DSC and dynamic mechanical analysis (DMA). The DMA is particularly useful with samples where melt phasing is present during the syntheses, i.e., showing two glass transition temperatures or a very broad Tg. Nuclear magnetic resonance (NMR) spectroscopy is used to determine the composition of the copolyether ester elastomer composition samples. The copolyether ester elastomer samples are dissolved in 1,1,2,2-tetra-chloroethane-D2 for these measurements. For mechanical property testing, the elastomer samples are compression molded and tested as follows: Hardness, Shore (ASTM D2240), Tensile Strength (ASTM D412), Young's Modulus (ASTM D412), Elongation at break (ASTM D412), Tear Strength, Die C (ASTM D1938), Taber Abrasion Loss (ASTM D1044), and Clash-Berg Torsional Stiffness (ASTM D1043).

This example uses a 2 liter stainless steel reactor fitted for distillation. A U-shaped stainless steel stirrer is placed about ⅛ inch from the bottom of the reactor. After the reactor is charged with the reagents, catalysts and additives, it is purged with nitrogen to remove air from the system. The reactor is then heated by an electric heater with agitator speed set at 100 rpm. The first reaction, the transesterification or ester interchange, typically starts at around 170° C., evidenced by the presence of methanol vapor in the distillation column at which point nitrogen flow is stopped. The ester interchange is continued until the reactor temperature reaches about 210° C. and methanol flow ceases to the distillation column. The distillation column is then removed and the reactor is connected to a vacuum system. The reactor temperature is slowly increased to 250° C. and full vacuum is obtained in about 30 minutes. The polycondensation reaction is continued for an additional period of time which is monitored and determined by the torque reading on the agitator under given rpm after full vacuum is obtained. After reaching the predetermined torque reading, the reactor is brought to ambient pressure by refilling with nitrogen, the plug in the bottom of the reactor is removed and the polymer melt is extruded, quenched in a water bath and pelletized by a rotating cutter. The reactor is capable of preparing up to 1 kg copolyether ester elastomer composition per batch.

All parts and percentages are by weight unless otherwise indicated.

### Example 4(A)

The 2 liter reactor is charged with 336 g DMT, 250 g BDO, 325 g random poly(oxyethylene-co-oxytetramethylene ether) glycol that has a molecular weight of 2025 g/mol and oxyethylene incorporation of 49 mol %, 0.692 g TBT catalyst, 0.128 g Mg acetate co-catalyst, and 0.940 g IRGANOX® 330 E antioxidant. The reactor is purged with nitrogen before heating. The agitator speed is set at 100 rpm. At approximately 170° C., methanol starts to appear in the overhead distillation column and the nitrogen flow is discontinued. Methanol take-off is started, and methanol is condensed and collected in a receiver. The reactor temperature is then slowly increased to approximately 210° C. The ester interchange finished when no more methanol is seen in the column. The port for the condenser is capped and the reactor temperature is slowly raised to 250° C. while full vacuum, around 0.1 torr, is reached at the same time. The polycondensation starts when the BDO is distilled off from the reactor. The polycondensation is conducted for 2.5 hours, at which point the torque reading on the agitator is around 400 N-cm at 20 rpm speed. The vacuum is then broken with nitrogen and the reactor is under slight pressure of about 3 psig. The hot copolyether ester elastomer product is extruded from the bottom of the reactor, quenched and cooled in a deionized water bath and pelletized using a cutter. The resulting copolyether ester elastomer composition is composed of 50 wt % PBT hard segment and 50 wt % poly(oxyethylene-co-oxytetramethylene ether) terephthalate soft segment.

### Example 4(B)

Example 4(A) is repeated except for charging the reactor with 350 g DMT, 264 g BDO, 282 g poly(oxyethylene-co-oxytetramethylene ether) glycol that had a molecular weight of 2025 g/mol and ethylene oxide incorporation of 49 mol %, 0.667 g TBT catalyst, 0.123 g Mg acetate co-catalyst, and 1.000 g IRGANOX® 330 E antioxidant. The resulting copolyether ester elastomer composition is composed of 55 wt % PBT hard segment and 45 wt % poly(oxyethylene-co-oxytetramethylene ether) terephthalate soft segment.

### Example 4(C)

Example 4(A) is repeated except for charging the reactor with 376 g DMT, 310 g BDO, 250 g poly(oxyethylene-co-oxytetramethylene ether) glycol that had a molecular weight of 2025 g/mol and ethylene oxide incorporation of 49 mol %, 0.499 g TBT catalyst, 0.123 g Mg acetate co-catalyst, and 0.665 g IRGANOX® 330 E antioxidant. The resulting copolyether ester elastomer composition is composed of 60 wt % PBT hard segment and 40 wt % poly(oxyethylene-co-oxytetramethylene ether) terephthalate soft segment.

### Example 4(D)

Example 4(A) is repeated except for charging the reactor with 305 g DMT, 227 g BDO, 294 g PTMEG that had a molecular weight of 2000 g/mol, 0.627 g TBT catalyst, 0.116 g Mg acetate co-catalyst, and 0.940 g IRGANOX® 330 E antioxidant. The resulting copolyether ester elastomer composition is composed of 40 wt % PBT hard segment and 60 wt % polytetramethylene ether terephthalate soft segment.

### Example 4(E)

Example 4(A) is repeated except for charging the reactor with 383 g DMT, 290 g BDO, 254 g PTMEG that had a molecular weight of 2000 g/mol, 0.508 g TBT catalyst, 0.125 g Mg acetate co-catalyst, and 1.016 g IRGANOX® 330 E antioxidant. The resulting copolyether ester elastomer composition is composed of 50 wt % PBT hard segment and 50 wt % polytetramethylene ether terephthalate soft segment.

### Example 4(F)

A quantity of commercially available copolyether ester elastomer is purchased from Ashland Inc. having 48 wt % PBT hard segment and 52 wt % EOPPG soft segment. The EOPPG block copolymer has a molecular weight of 2100 g/mol and ethylene oxide incorporation of 36 mol %. The team “EOPPG”, as used herein, unless otherwise indicated, means ethylene oxide capped polypropylene ether glycol.

Products of the above experiments are tested for various properties. The results of these tests are presented in Table 3 below.

TABLE 3

| | Example | | | | | |
|---|---|---|---|---|---|---|
| Property | 4(A) | 4(B) | 4(C) | 4(D) | 4(E) | 4(F) |
| PBT, wt % | 50 | 55 | 60 | 40 | 50 | 48 |
| SS ⁽¹⁾ Mw. | 2025 | 2025 | 2025 | 2000 | 2000 | 2100 |
| SS Type | (2) | (2) | (2) | PTMEG | PTMEG | EOPPG ⁽³⁾ |
| Shore D | 47 | 51 | 52 | 47 | 48 | 50 |
| Tensile Strength, psi | 5735 | 6175 | 6970 | 3500 | 5100 | 2949 |
| Young's Modulus | 1880 | 2222 | 2718 | 1722 | 2200 | 2181 |
| M100 psi | | | | | | |
| % UE | 860 | 912 | 1018 | 529 | 620 | 299 |
| Die C Tear St. ppi | 578 | 604 | 707 | 579 | 751 | 526 |
| Taber Abrasion Loss | 83.8 | 93.9 | 86.9 | 98.2 | 91.0 | 153.8 |
| (mg/1000 rpm) ⁽⁴⁾ | | | | | | |
| Tg by Tan δ (° C. ) | −63 | −60.8 | −61.6 | −57.4 (broad) | −70, 10 | −51.8 |
| Tan δ @ 25° C. | 0.033 | 0.032 | 0.033 | 0.043 | 0.093 | 0.033 |
| Clash-Berg Stiffness ⁽⁵⁾ | −93.9 | −86.5 | −79.8 | −81.7 | −49.4 | −72.8 |
| T(° C. ) = 45,000 psi | | | | | | |

⁽¹⁾ SS is soft segment
(2) poly(oxyethylene-co-oxytetramethylene ether) glycol with 49 mol % oxyethylene ether
⁽³⁾ block copolymer of EOPPG with 36 mol % oxyethylene ether
⁽⁴⁾ H-22 wheel
⁽⁵⁾ Clash-Berg torsional stiffness test

### Examples 5(a-o)

### Compositions of Polyolefins with Improved Gas Barrier Properties

General method of additive incorporation into polyolefins The additive formulations, prepared according to the methods described in Examples 1-3 and 4 are incorporated into a polyolefin matrix using a twin-screw compounder. Prior to compounding, the base polyolefin and selected solid additive components are individually micronized using a cryogenic grinding method using conventional equipment, then dried. The finely ground powders are intimately mixed using such conventional solids mixing equipment as a tumbler mixer, rotating mixer, fluidized mixer, screw powder mixer, etc. The intimately mixed materials are fed to the compounder for compounding.

For compositions where liquid additives are used, the pre-determined amount of flowable liquid additive may be introduced at the throat of the compounding equipment at desirable processing conditions.

The compounded composite is then injection molded using conventional equipment into 1 mm thick plaques. The molded plaques are stretch-oriented into planar films at an orientation level similar to a polyolefin bottle made by conventional blow molding. Biaxial 2×2 planar stretching of the molded plaques would typically produce stretched planar films that may represent the polyolefin bottle sidewall thicknesses of at least 0.25 mm. Biaxial 4×4 planar stretching of the molded plaques would typically produce stretched planar films that may represent the polyolefin bottle sidewall thicknesses of at least 0.0625 mm.

In one embodiment, the base polyolefin is bottle-grade polypropylene (PP). The PP resin and the solid additives are ground into powder to achieve more sufficient mixing. Mixing is performed in a tumbler for at least 30 minutes before extrusion. The compounded PP resin powder is kept under an inert atmosphere, such as under nitrogen purge, before injection molding to avoid unnecessary loss of oxygen scavenger due to oxygen exposure. The compounded PP resin is then injection molded into a 6 cm×6 cm×0.1 cm plaque mold. The molded plaques are stretch oriented into uniformly oriented films using a TM long film stretcher. The stretched films represent an orientation level similar to the blow-molded PP bottle sidewall. These films are individually tested to determine the oxygen and carbon dioxide permeability.

In one embodiment, a stretched film is epoxied directly onto a fixture, which is mounted onto an OxyTraQ™ device. One side of the film is flushed internally with a nitrogen purge while the outside is left exposed to ambient air. The nitrogen purge carries a sample gas past an oxygen detector, which determines the amount of O₂ permeating through the film. The sample is tested in a controlled temperature environment at 23° C. and 50% relative humidity (RH). The O₂ permeation rate is evaluated until the sample reaches equilibrium, as determined by plateauing permeation values over time. For long term O₂ testing with oxygen scavengers, the film is initially tested to determine their equilibrium permeation rate and placed onto a purging station until the next oxygen permeation measurement is taken.

For long-term testing, the test specimen is re-attached onto the OxyTraQ™ device at exposure day 0 (start), 3, 5, 7, 14, 21, 28, 42, 98, 126 and 154 and analyzed for O₂ permeation for up to three days. The test intervals may be readjusted if the intervals need to be added or removed based on the observations during the test.

In one embodiment, the intimately-mixed additive component material may include no more than about 10 parts by weight of polymer containing an oxidizable component (such as COPE), no more than about 20 parts by weight of compatibilizing agent (such as maleic anhydride, polypropylene grafted maleic anhydride, pyromellitic dianhydride, or other suitable compatibilizer), about 0.01 to 98 parts by weight of base polymer (such as polyolefin or polyester), about 10 to 200 ppm by weight of metal catalyst (such as cobalt, Iron, etc.). In another embodiment, about 0.25 to 10 parts by weight of the additive component mixture may be combined with a base polymer (such as polyolefin) to form the polyolefin composition having improved oxygen barrier protection.

Table 4 below provides the polyolefin compositions of stretched film samples, prepared according to the methods described herein, tested for the oxygen barrier protection. The use of these polyolefin compositions effectively demonstrates improved gas barrier properties.

TABLE 4

| | Polyolefin part | Sacrificial Polymer | | Compatibilizer | Catalyst | Other additives |
|---|---|---|---|---|---|---|
| Sample | by wt | part by wt | | Part by wt | part by wt | Part by wt |
| 5a | 100 LDPE | CONTROL | | — | — | — |
| | 99 parts LDPE | 1 | part of (3) | — | — | — |
| | 98 parts LDPE | 2 | parts of (3) | — | — | — |
| | 95 parts LDPE | 5 | parts of (3) | — | — | — |
| | 99 parts LDPE | 1 | part of (4) | <20 | 10-200 ppm | <10 |
| | 98 parts LDPE | 2 | parts of (4) | ″ | ″ | ″ |
| | 95 parts LDPE | 5 | parts of (4) | ″ | ″ | ″ |
| | 99.5 parts LDPE | 0.5 | T ®1400 | ″ | ″ | ″ |
| | 99 parts LDPE | 1.0 | T ®1400 | ″ | ″ | ″ |
| | 98 parts LDPE | 2.0 | T ®1400 | ″ | ″ | ″ |
| | 95 parts LDPE | 5.0 | T ®1400 | ″ | ″ | ″ |
| 5b | Repeat 5a using | CONTROL | | ″ | ″ | ″ |
| | LLDPE | 1 | part of (3) | | | |
| | | 2 | parts of (3) | | | |
| | | 5 | parts of (3) | | | |
| | | 1 | part of (4) | | | |
| | | 2 | parts of (4) | | | |
| | | 5 | parts of (4) | | | |
| | | 0.5 | T ®1400 | | | |
| | | 1.0 | T ®1400 | | | |
| | | 2.0 | T ®1400 | | | |
| | | 5.0 | T ®1400 | | | |
| 5c | Repeat 5a using | CONTROL | | ″ | ″ | ″ |
| | HDPE | 1 | part of (3) | | | |
| | | 2 | parts of (3) | | | |
| | | 5 | parts of (3) | | | |
| | | 1 | part of (4) | | | |
| | | 2 | parts of (4) | | | |
| | | 5 | parts of (4) | | | |
| | | 0.5 | T ®1400 | | | |
| | | 1.0 | T ®1400 | | | |
| | | 2.0 | T ®1400 | | | |
| | | 5.0 | T ®1400 | | | |
| 5d | Repeat 5a using | CONTROL | | ″ | ″ | ″ |
| | PP | 1 | part of (3) | | | |
| | | 2 | parts of (3) | | | |
| | | 5 | parts of (3) | | | |
| | | 1 | part of (4) | | | |
| | | 2 | parts of (4) | | | |
| | | 5 | parts of (4) | | | |
| | | 0.5 | T ®1400 | | | |
| | | 1.0 | T ®1400 | | | |
| | | 2.0 | T ®1400 | | | |
| | | 5.0 | T ®1400 | | | |
| 5c | Repeat 5a using | CONTROL | | ″ | ″ | ″ |
| | EP | 1 | part of (3) | | | |
| | | 2 | parts of (3) | | | |
| | | 5 | parts of (3) | | | |
| | | 1 | part of (4) | | | |
| | | 2 | parts of (4) | | | |
| | | 5 | parts of (4) | | | |
| | | 0.5 | T ®1400 | | | |
| | | 1.0 | T ®1400 | | | |
| | | 2.0 | T ®1400 | | | |
| | | 5.0 | T ®1400 | | | |
| 5f | Repeat 5a using | CONTROL | | ″ | ″ | ″ |
| | EB | 1 | part of (3) | | | |
| | | 2 | parts of (3) | | | |
| | | 5 | parts of (3) | | | |
| | | 1 | part of (4) | | | |
| | | 2 | parts of (4) | | | |
| | | 5 | parts of (4) | | | |
| | | 0.5 | T ®1400 | | | |
| | | 1.0 | T ®1400 | | | |
| | | 2.0 | T ®1400 | | | |
| | | 5.0 | T ®1400 | | | |
| 5g | Repeat 5a using | CONTROL | | ″ | ″ | ″ |
| | EH | 1 | part of (3) | | | |
| | | 2 | parts of (3) | | | |
| | | 5 | parts of (3) | | | |
| | | 1 | part of (4) | | | |
| | | 2 | parts of (4) | | | |
| | | 5 | parts of (4) | | | |
| | | 0.5 | T ®1400 | | | |
| | | 1.0 | T ®1400 | | | |
| | | 2.0 | T ®1400 | | | |
| | | 5.0 | T ®1400 | | | |
| 5h | Repeat 5a using | CONTROL | | ″ | ″ | ″ |
| | EO | 1 | part of (3) | | | |
| | | 2 | parts of (3) | | | |
| | | 5 | parts of (3) | | | |
| | | 1 | part of (4) | | | |
| | | 2 | parts of (4) | | | |
| | | 5 | parts of (4) | | | |
| | | 0.5 | T ®1400 | | | |
| | | 1.0 | T ®1400 | | | |
| | | 2.0 | T ®1400 | | | |
| | | 5.0 | T ®1400 | | | |
| 5i | Repeat 5a using | CONTROL | | ″ | ″ | ″ |
| | EPDM | 1 | part of (3) | | | |
| | | 2 | parts of (3) | | | |
| | | 5 | parts of (3) | | | |
| | | 1 | part of (4) | | | |
| | | 2 | parts of (4) | | | |
| | | 5 | parts of (4) | | | |
| | | 0.5 | T ®1400 | | | |
| | | 1.0 | T ®1400 | | | |
| | | 2.0 | T ®1400 | | | |
| | | 5.0 | T ®1400 | | | |
| 5j | Repeat 5a using | CONTROL | | ″ | ″ | ″ |
| | EPO | 1 | part of (3) | | | |
| | | 2 | parts of (3) | | | |
| | | 5 | parts of (3) | | | |
| | | 1 | part of (4) | | | |
| | | 2 | parts of (4) | | | |
| | | 5 | parts of (4) | | | |
| | | 0.5 | T ®1400 | | | |
| | | 1.0 | T ®1400 | | | |
| | | 2.0 | T ®1400 | | | |
| | | 5.0 | T ®1400 | | | |
| 5k | Repeat 5a using | CONTROL | | ″ | ″ | ″ |
| | SEBS-g-MA | 1 | part of (3) | | | |
| | | 2 | parts of (3) | | | |
| | | 5 | parts of (3) | | | |
| | | 1 | part of (4) | | | |
| | | 2 | parts of (4) | | | |
| | | 5 | parts of (4) | | | |
| | | 0.5 | T ®1400 | | | |
| | | 1.0 | T ®1400 | | | |
| | | 2.0 | T ®1400 | | | |
| | | 5.0 | T ®1400 | | | |
| 5l | Repeat 5a using | CONTROL | | ″ | ″ | ″ |
| | PE-g-MA | 1 | part of (3) | | | |
| | | 2 | parts of (3) | | | |
| | | 5 | parts of (3) | | | |
| | | 1 | part of (4) | | | |
| | | 2 | parts of (4) | | | |
| | | 5 | parts of (4) | | | |
| | | 0.5 | T ®1400 | | | |
| | | 1.0 | T ®1400 | | | |
| | | 2.0 | T ®1400 | | | |
| | | 5.0 | T ®1400 | | | |
| 5m | Repeat 5a using | CONTROL | | ″ | ″ | ″ |
| | PP-g-MA | 1 | part of (3) | | | |
| | | 2 | parts of (3) | | | |
| | | 5 | parts of (3) | | | |
| | | 1 | part of (4) | | | |
| | | 2 | parts of (4) | | | |
| | | 5 | parts of (4) | | | |
| | | 0.5 | T ®1400 | | | |
| | | 1.0 | T ®1400 | | | |
| | | 2.0 | T ®1400 | | | |
| | | 5.0 | T ®1400 | | | |
| 5m | Repeat 5a using | CONTROL | | ″ | ″ | ″ |
| | PB | 1 | part of (3) | | | |
| | | 2 | parts of (3) | | | |
| | | 5 | parts of (3) | | | |
| | | 1 | part of (4) | | | |
| | | 2 | parts of (4) | | | |
| | | 5 | parts of (4) | | | |
| | | 0.5 | T ®1400 | | | |
| | | 1.0 | T ®1400 | | | |
| | | 2.0 | T ®1400 | | | |
| | | 5.0 | T ®1400 | | | |
| 5o | Repeat 5a using | CONTROL | | ″ | ″ | ″ |
| | PI | 1 | part of (3) | | | |
| | | 2 | parts of (3) | | | |
| | | 5 | parts of (3) | | | |
| | | 1 | part of (4) | | | |
| | | 2 | parts of (4) | | | |
| | | 5 | parts of (4) | | | |
| | | 0.5 | T ®1400 | | | |
| | | 1.0 | T ®1400 | | | |
| | | 2.0 | T ®1400 | | | |
| | | 5.0 | T ®1400 | | | |

LDPE is low-density polyethylene
HDPE is high-density polyethylene
EP is ethylene-propylene copolymer
EH is ethylene-hexane copolymer
EPDM is ethylene-propylene-diene interpolymer
LLDPE is linear low-density polyethylene
PP is polypropylene (propylene homopolymer)
EB is ethylene-butylene copolymer
EO is ethylene-octene copolymer
EPO is ethylene-propylene-octene terpolymer
(3) is additive composition prepared according to Examples 1-3
T ®1400 is INVISTA TERATHANE ® PTMEG 1400 Glycol
Compatilizer such as pyromellitic anhydride (PMA)
HALS is hindered amine light stabilizer, such as Uvinul ® 4050 (CAS No. 124172-53-8)
(4) is additive composition prepared according to Examples 4(A-F)
SEBS-g-MA is a thermoplastic elastomer grafted with maleic anhydride (MA)
PE-g-MA is polyethylene grafted with maleic anhydride (MA)
PP-g-MA is polypropylene grafted with maleic anhydride (MA)
PB is polybutadiene
PI is polyisoprene

The stretched planar films using the polyolefin composites described in Table 4, and prepared according to the method described in Example 4, are tested for O₂ and CO₂ barrier protection. The use of these polyolefin compositions is effective in demonstrating improved O₂ and CO₂ barrier properties.

### Example 6

CO₂ barrier elements are prepared into micro domains by dispersing nano-component carriers of the active oxygen scavenging components. These components may consist of organic or inorganic particles to which the sacrificial polymer and catalyst are attached either by chemical or physical means.

Surface active silica is micronized, then coated with the cobalt containing ionomeric COPE sacrificial polymer. When dispersed into the polyolefin matrix, this material provides both an active and passive oxygen barrier. Similarly, the micronized carrier is a sacrificial polymer (such as COPE or nylon MXD6) with catalyst, which having end group functionality is capable of forming micro-domain micelles in the polyolefin matrix capable of passive and active barrier. The barrier properties are especially improved when the end groups contain some portion of compatibilizing agent which is useful in providing a more homogeneous system.

In the examples of Table 4, polypropylene (PP) used may be a bottle-grade resin such as PolyOne® 23N10A, a Flint Hills Resources polypropylene random copolymer. Other suitable polypropylene base polymers may include VERSIFY™ polymers (The Dow Chemical Company) and VISTAMAXX™ polymers (ExxonMobil Chemical Co.), LICOCENE™ polymers (Clariant), EASTOFLEX™ polymers (Eastman Chemical Co.), REXTAC™ polymers (Hunstman), Basell-Polyolefin (Basell) and VESTOPLAST™ polymers (Degussa). Other suitable polymers may include propylene-α-olefin block copolymers and interpolymers, polypropylene made from metallocene or post metallocene catalysts and catalytic processes, and other propylene-based random, block, heterophasic, or otherwise suitable copolymer and interpolymers known in the art.

In some embodiments, halogenated ethylene-based polymers may include chlorinated ethylene-based polymers and fluorinated ethylene-based polymers. Suitable chlorinated ethylene-based polymers include Tyrin™ chlorinated polymers available from The Dow Chemical Company.

Examples of suitable chlorinated ethylene copolymers, which may be employed in the compositions according to Table 4, may include copolymers of ethylene with propylene, 1-butene, 3-methyl-1-pentene, 1-pentene, 1-hexene, 1-heptene or 1-octene. The interpolymers may be copolymers, terpolymers, or higher order copolymers. Chlorinated ethylene ester copolymers, such as chlorinated ethylene methyl acrylate and chlorinated ethylene methyl methacrylate, may also be suitable for used in the invention.

Suitable polybutadienes (PB) may include, but are not limited to, natural cis-1,4-polybutadiene, trans-1,4-polybutadiene, vinyl-1,2-polybutadiene, copolymers of styrene and butadiene, copolymers of isoprene and butadiene, and interpolymers of styrene, isoprene and butadiene. Examples of suitable polybutadienes include EUROPRENE NEOCIS BR 40 from POLIMERI EUROPA, and BUNA CB 24 from LANXESS.

In Table 4, polyisoprenes (PI) may include both natural polyisprene and synthetic polyisoprene. Suitable polyisoprenes include, but are not limited to, natural cis-1,4-polyisoprene, synthetic cis-1,4-polyisoprene, high vinyl 3,4-polyisoprene and 3,4-polyisoprene. Suitable examples of polyisoprenes may include the following technical grades: SMR (Standard Malaysian Rubber), such as SRM 5 and SMR 20; TSR (Technical Specified Rubber) and RSS (Ribbed Smoked Sheets).

In the compositions of Table 4, cobalt carriers may include but are not limited to cobalt carbonate, cobalt stearate, cobalt acetylacetonate, cobalt diethylamine, cobalt dilinoleate mixed valence cobalt(III)/cobalt(II) ion-pair complexes such as [CoCO₃(2,2′-bipyridine)₂]₂, [Co(demethylcantharidate) ₂], exo-1,4-epoxy-cyclohexyl-2,3-dicarboxylate group, (C₈H8O₅)₂, polymers containing a cobalt porphyrin, complexes such as [a,a′,a″,a′″-meso-tetrakis(o-pivalamidophenyl) porphinato]cobalt(II) 1-methylimidazole (CoPIm), and polymeric cobalt(II). Other examples include cobalt montmorillonite, monoglycerolate, and other polymeric cobalt containing structures, as those described in Polymeric Materials Encyclopedia, CRC Press, 1996, Vol. 6, pp 4823-4826.

In the compositions of Table 4, compatibilizers may include polyolefins grafted with COPE, maleic anhydride grafted polypropylene or polyvinyl pyrrolidone, maleic anhydride (MAH), PTMEG and combinations thereof. In some embodiments, PP compatibilizers may include MA grafted on PP (PP-g-MAH), maleic anhydride grafted styrene-ethylene/butylene-styrene (SEBS-g-MAH), MAH and butyl methacrylate (BMA) co-polymer grafted on PP, and BMA grafted on low density PP.

The improved gas bather protection provided by the present invention may also be applicable to some of the biopolymers (for example, polylactic acid) as they are also candidates for barrier improvement. Recent polymeric materials developed in the field of polyesters to be used in the food packaging may include aliphatic biodegradable polymers; poly(butylene succinate) (PBS) and poly(butylene succinate-coadipate) (PBSA). Both, PBS and PBSA have been evaluated for food packing application, including barrier parameters. Other non-limiting examples of biopolymer are polylactide, polylactide-co-glycolide and poly(β-hydroxyalkanates) or PHA.

### Examples 7(a-d)

### Polypropylene Cobalt Stearate Masterbatch (Catalyst-MB) Preparation

The polypropylene-based polymer used herein is a commercial polypropylene (PP) product of TOTAL Petrochemicals identified as “TOTAL Lumicene® MR10MX0”. It is a metallocene random copolymer and it is used as received.

The maleic anhydride grafted polypropylene (PP-g-MA) used herein is a commercial product of Arkema “Orevac® CA 100”. It is used as received in a premix with PP to provide the matrix material/source material for the extrusion step.

Cobalt stearate, sodium stearate and Ethanox® 330 are added directly in the melt extrusion step, respectively. The melt extruder used is a co-rotating, 27 mm extruder screw diameter and screw length to diameter (L:D) ratio of 36:1, for example, Leistritz Micro 27 36D model melt extruder. The polymer processing rate is about 5 kg/hr. Stage-wise operating temperatures are: water at room temperature (T0), 200° C. (T1), 222° C. (T2), 240° C. (T3), 220° C. (T4), 205° C. (T5-T7), 210° C. (T8) and 220° C. (T9). The desired molten material is extruded into a deionized water cooling bath. The cooled polymer strands are pelletized with a Pell-tee pelletizer into typical cylindrical granules of about 2 mm diameter and about 3 mm length.

Either of the stearate and/or PP-g-MA in the final Cobalt stearate Masterbatch (Catalyst-MB) composition may be varied by adjusting the amounts of stearate and/or PP-g-MA, respectively.

In one embodiment, 1000 kg of Catalyst-MB product is prepared using the following component quantities as listed in Table 5.

TABLE 5

| | 7a | 7b | 7c | 7d |
|---|---|---|---|---|
| | Amount, | Amount, | Amount, | Amount, |
| Component | kg | kg | kg | kg |
| Polypropylene | 920 | 736 | 722.6 | 722.6 |
| Lumicene ® | | | | |
| PP-g-MA Orevac ® | 0 | 184 | 180.7 | 180.6 |
| CA 100 | | | | |
| Cobalt Stearate | 80 | 80 | 80 | 80 |
| Ethanox ® 330 | 0 | 0 | 0 | 0.1 |
| Sodium Stearate | 0 | 0 | 16.7 | 16.7 |

TABLE 5A
Additional Embodiments

| | 7a | 7b | 7c | 7d |
|---|---|---|---|---|
| | Amount, | Amount, | Amount, | Amount, |
| Component | kg | kg | kg | kg |
| Polypropylene | 910-930 | 665-740 | 650-795 | 650-795 |
| Lumicene ® | | | | |
| PP-g-MA Orevac ® | 0 | 166-202 | 160-200 | 160-200 |
| CA 100 | | | | |
| Cobalt Stearate | 70-90 | 70-90 | 70-90 | 70-90 |
| Ethanox ® 330 | 0 | 0 | 0 | 0.5-1.5 |
| Sodium Stearate | 0 | 0 | 15-17 | 15-17 |

### Example 8

### MXD6 Additive Preparation

The polypropylene-based polymer used herein is a commercial polypropylene (PP) product of TOTAL Petrochemicals identified as “TOTAL Lumicene® MR10MX0”. It is a metallocene random copolymer and it is used as received.

An aromatic polyamide used herein is a commercial polyamide poly(m-xylene adipamide) (MXD6) product of Mitsubishi Gas Chemical Company, “MXD6 S6007” and it is used as received.

The maleic anhydride grafted polypropylene (PP-g-MA) used herein is a commercial product of Arkema “Orevac® CA 100”. It is used as received in a premix with PP and MXD6 to provide the source material for the extrusion step.

The melt extruder used is a co-rotating, 27 mm extruder screw diameter and screw length to diameter (L:D) ratio of 36:1, for example, Leistritz Micro 27 36D model melt extruder. The polymer processing rate is about 5 kg/hr. Stage-wise operating temperatures are: water at room temperature (T0), 240° C. (T1), 250° C. (T2-T8), and 255° C. (T9). The desired molten material is extruded into a deionized water cooling bath. The cooled polymer strands are pelletized with a Pell-tec pelletizer into typical cylindrical granules of about 2 mm diameter and about 3 mm length.

Either of the polyamide and/or PP-g-MA in the final MXD6 additive composition may be varied by adjusting the amounts of polyamide and/or PP-g-MA, respectively.

In one embodiment, 1000 kg of MXD6 additive product is prepared using the following component quantities as listed in Table 6.

TABLE 6

| | 8 |
|---|---|
| Component | Amount, kg |
| Polypropylene Lumicene ® | 200 |
| MXD6 S6007 | 400 |
| PP-g-MA Orevac ® CA 100 | 400 |

TABLE 6A
Additional Embodiments

| | 8 |
|---|---|
| Component | Amount, kg |
| Polypropylene Lumicene ® | 180-220 |
| MXD6 S6007 | 360-440 |
| PP-g-MA Orevac ® CA 100 | 360-440 |

### Example 9

### Incorporation of Catalyst Masterbatch and MXD6 (Additive) into Polyolefins

Catalyst Masterbatch and MXD6 (pure or as additive shown in Table 6) may be mixed prior to use for injection molding with any polyolefin base resin.

In this example Catalyst Masterbatch as shown in Examples 7a-d is used in concentrations of 5-8 wt % for injection molding into preforms and further stretch blow molding into bottles. MXD6 may be used pure or as an additive (cf. example 8) in a premix with the base resin or premixed with catalyst masterbatch to obtain 10 wt % MXD6 in the final application. The MXD6 amount may be varied by adjusting the amounts of MXD6/MXD6 additive.

### Example 10

### Effect of Preform Storage Time

Bottles stretch blow molded of preforms made from compositions of Examples 7d and 8 show enhanced oxygen barrier properties when preforms are stored for several days.

### Examples 11(a-b)

### Polyether Additive Preparation

The polypropylene-based polymer used herein is a commercial polypropylene (PP) product of TOTAL Petrochemicals identified as “TOTAL Lumicene® MR10MX0”. It is a metallocene random copolymer and it is used as received. As used in this example, polytetramethylene ether glycol (Terathane® PTMEG 1400) is obtained from INVISTA.

The maleic anhydride grafted polypropylene (PP-g-MA) used herein is a commercial product of Arkema “Orevae® CA 100”. It is used as received in a premix with PP and PTMEG to provide the source material for the extrusion step. Uvinul® 4050 and Ethanox® 330 are added to PTMEG before premixing with PP and PP-g-MA, respectively. The premix is directly fed into the extruder.

The melt extruder used is a co-rotating, 27 mm extruder screw diameter and screw length to diameter (L:D) ratio of 36:1, for example, Leistritz Micro 27 36D model melt extruder. The polymer processing rate is about 5 kg/hr. Stage-wise operating temperatures are: water at room temperature (T0), 200° C. (T1-T4), 205° C. (T5-T7), 210° C. (T8) and 220° C. (T9). The desired molten material is extruded into a deionized water cooling bath. The cooled polymer strands are pelletized with a Pell-tec pelletizer into typical cylindrical granules of about 2 mm diameter and about 3 mm length.

Either of the PTMEG and/or PP-g-MA in the final polyether additive composition may be varied by adjusting the amounts of polyether and/or PP-g-MA, respectively. Either of the Uvinul® 4050 and/or Ethanox® 330 in the final polyether additive composition may be varied by adjusting the amounts of Uvinul® 4050 and/or Ethanox® 330, as well.

In one embodiment, 1000 kg of polyether additive product may be prepared using the following component quantities as listed in Table 7.

TABLE 7

| | 11a | 11b |
|---|---|---|
| Component | Amount, kg | Amount, kg |
| Polypropylene | 900 | 300 |
| Terathane ® PTMEG 1400 | 89.8 | 198.63 |
| PP-g-MA Orevac ® CA | 0 | 500 |
| Uvinul ® 4050 | 1 | 1.33 |
| Ethanox ® 330 | 0.02 | 0.04 |

TABLE 7A
Additional Embodiments

| | 11a | 11b |
|---|---|---|
| Component | Amount, kg | Amount, kg |
| Polypropylene | 910-930 | 270-330 |
| Terathane ® PTMEG 1400 | 80-100 | 180-220 |
| PP-g-MA Orevac ® CA | 0 | 450-550 |
| Uvinul ® 4050 | 0.5-1.5 | 0.5-2.0 |
| Ethanox ® 330 | 0.01-0.03 | 0.02-0.06 |

### Example 12

### Incorporation of Catalyst Masterbatch and Polyether Additive into Polyolefins

Catalyst masterbatch and polyether additive may be mixed prior to use for injection molding with any polyolefin base resin.

In this example, catalyst masterbatch as shown in Examples 7a-d is used in concentrations of 5-8 wt % for injection molding into preforms and further stretch-blow molding into bottles. Polyether additive (cf. Example 11a-b) may be used in a premix with the base resin or premixed with catalyst masterbatch to obtain approximately 2.5 wt % Terathane® PTMEG 1400 in the final application. PTMEG amount may be varied by using different amounts of polyether additive.

All patents, patent applications, test procedures, priority documents, articles, publications, manuals, and other documents cited herein are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

While the illustrative embodiments of the invention have been described with particularity, it will be understood that various other modifications will be apparent to and may be readily made by those skilled in the art without departing from the spirit and scope of the invention. Accordingly, it is not intended that the scope of the claims hereof be limited to the examples and descriptions set forth herein but rather that the claims be construed as encompassing all the features of patentable novelty which reside in the present invention, including all features which would be treated as equivalents thereof by those skilled in the art to which the invention pertains.

1. A composition comprising:
a) polyolefin,
b) polymer containing an oxidizable component, said polymer selected from the group consisting of polyethers, copolyether esters, copolyether amides, polyether glycols, at least partially aromatic polyamides, and combinations thereof,
c) transition metal or metal compound, and
d) optionally separately added additive,
said composition characterized in that when an article is formed therefrom and oriented in the x and/or y direction, the article exhibits lower oxygen and/or carbon dioxide transmission than an article formed from a composition without components b) and c) when oriented in the x and/or y direction, or with components b) and c) when not oriented in the x and/or y direction, compared with a control.

2. The composition of claim 1 comprising:
a) from 90 to 99 parts polyolefin,
b) from 0.1 to 10 parts of polymer containing an oxidizable component, said polymer selected from the group consisting of polyethers, copolyether esters, copolyether amides, polyether glycols, at least partially aromatic polyamides, and combinations thereof,
c) from 10 to 1000 parts per million (ppm) of transition metal or metal compound, and
d) optionally from 0 to 5 parts of separately added additive,
said composition characterized in that when an article is formed therefrom and oriented in the x and/or y direction from 50 to 400%, the article exhibits lower oxygen and/or carbon dioxide transmission than an article formed from a composition without components b) and c) when oriented in the x and/or y direction from 50 to 400%, or with components b) and c) when not oriented in the x and/or y direction from 50 to 400%, compared with a control.

3. The composition of claim 1 wherein the polymer b) containing an oxidizable component comprises a polyether, and wherein the separately added additive d) comprises at least one compatibilizing agent.

4. The composition of claim 3 wherein the compatibilizing agent is selected from the group consisting of polyolefins grafted with COPE, maleic anhydride grafted polypropylene, maleic anhydride grafted polyvinyl pyrrolidone, maleic anhydride (MAH), PTMEG, and combinations thereof.

5. The composition of claim 1 wherein the transition metal is cobalt and is present at 600 ppm or less.

6. The composition of claim 1 wherein the separately added additive d) comprises stabilizer.

7. The composition of claim 6 wherein the stabilizer comprises a monomeric, oligomeric or polymeric hindered amine light stabilizer (HALS).

8. The composition of claim 1 wherein an article formed therefrom has been oriented at least 50% in the x and/or y direction.

9. The composition of claim 1 wherein an article formed therefrom has been oriented at least 100% in the x and/or y direction.

10. The composition of claim 1 which is liquid at 25° C.

11. The composition of of claim 1 wherein the polymer b) containing an oxidizable component comprises MXD6 polyamide.

12. A film having improved oxygen and/or carbon dioxide barrier properties comprising:
a) polyolefin,
b) polymer containing an oxidizable component, said polymer selected from the group consisting of polyethers, copolyether esters, copolyether amides, polyether glycols, at least partially aromatic polyamides, and combinations thereof,
c) transition metal or metal compound, and
d) optionally separately added additive,
said film having been oriented in the x and/or y direction from 50 to 400%.

13. The film of claim 12 comprising:
a) from 90 to 99.5 parts polyolefin,
b) from 0.1 to 10 parts of polymer containing an oxidizable component, said polymer selected from the group consisting of polyethers, copolyether esters, copolyether amides, polyether glycols, at least partially aromatic polyamides, and combinations thereof,
c) from 10 to 600 parts per million (ppm) of transition metal or metal compound, and
d) optionally from 0 to 5 parts of separately added additive.

14. The film of claim 12 wherein the polymer b) containing an oxidizable component comprises a polyether, and wherein the separately added additive d) comprises at least one compatibilizing agent.

15. The film of claim 14 wherein the compatibilizing agent is selected from the group consisting of polyolefins grafted with COPE, maleic anhydride grafted polypropylene, maleic anhydride grafted polyvinyl pyrrolidone, maleic anhydride (MAH), PTMEG, and combinations thereof.

16. The film of claim 12 wherein the separately added additive d) comprises stabilizer.

17. The film of claim 12 wherein the polymer b) containing an oxidizable component comprises MXD6 polyamide.

18. A rigid or semi-rigid article having improved oxygen and/or carbon dioxide barrier properties comprising:
a) polyolefin,
b) polymer containing an oxidizable component, said polymer selected from the group consisting of polyethers, copolyether esters, copolyether amides, polyether glycols, at least partially aromatic polyamides, and combinations thereof,
c) transition metal or metal compound, and
d) optionally separately added additive,
said rigid or semi-rigid article having been oriented in the x and/or y direction from 50 to 400%.

19. The article of claim 18 comprising:
a) from 90 to 99.5 parts polyolefin,
b) from 0.1 to 10 parts of polymer containing an oxidizable component, said polymer selected from the group consisting of polyethers, copolyether esters, copolyether amides, polyether glycols, at least partially aromatic polyamides, and combinations thereof,
c) from 10 to 600 parts per million (ppm) of transition metal or metal compound, and
d) optionally from 0 to 5 parts of separately added additive.

20. The article of claim 18 wherein the polymer b) containing an oxidizable component comprises a polyether, and wherein the separately added additive d) comprises at least one compatibilizing agent.

21. The article of claim 20 wherein the compatibilizing agent is selected from the group consisting of polyolefins grafted with COPE, maleic anhydride grafted polypropylene, maleic anhydride grafted polyvinyl pyrrolidone, maleic anhydride (MAH), PTMEG, and combinations thereof.

22. The article of claim 18 wherein the separately added additive d) comprises stabilizer.

23. The article of claim 18 having been blow-molded.

24. The blow-molded article of claim 23 comprising a bottle.

25. The article of claim 18 wherein the polymer b) containing an oxidizable component comprises MXD6 polyamide.
